(19) United States
(12) Patent Application Publication
(10) Pub. No.: US 2020/0134581 A1
(43) Pub. Date: Apr. 30, 2020

(54) BLOCKCHAIN BALANCE ADJUSTMENT

(71) Applicant: Alibaba Group Holding Limited, George Town (KY)

(72) Inventors: Danqing Hu, Hangzhou (CN); Xuebing Yan, Hangzhou (CN)

(73) Assignee: Alibaba Group Holding Limited, George Town (KY)

(21) Appl. No.: 16/723,365

(22) Filed: Dec. 20, 2019

Related U.S. Application Data
(63) Continuation of application No. 16/251,995, filed on Jan. 18, 2019.

(30) Foreign Application Priority Data
Jan. 19, 2018 (CN) 201810055698.5

(51) Int. Cl. G06Q 20/10; G06F 16/903; H04L 9/06; G06Q 20/06; H04L 9/32

(52) U.S. Cl. CPC G06Q 20/102; G06F 16/90335; H04L 9/0637; H04L 2209/56; H04L 9/3239; H04L 2209/38; G06Q 20/0655

(57) ABSTRACT

Techniques for adjusting blockchain balances are described. One example of a method includes detecting changes to blockchain balances deposited on an anchor point in a blockchain, wherein the changes to the blockchain balances are caused by transactions submitted by one or more members of a blockchain network that maintains the blockchain; querying, by a member of the blockchain network associated with the anchor point, a blockchain balance deposited on the anchor point in the blockchain; determining whether a changed amount of the blockchain balance is greater than or equal to a predetermined change threshold; and in response to determining that the changed amount of the blockchain balance is greater than or equal to a predetermined change threshold, initiating, by the member, a balance adjusting contract operation to adjust the blockchain balance so that the changed amount is less than the predetermined change threshold.

### CROSS-REFERENCE TO RELATED APPLICATIONS

This application is a continuation of U.S. application Ser. No. 16/251,995 filed on Jan. 18, 2019, which application claims priority to Chinese Patent Application No. 201810055698.5, filed on Jan. 19, 2018, the contents of the prior U.S. and Chinese applications are hereby incorporated by reference in their entirety.

### TECHNICAL FIELD

One or more implementations of the specification relate to the field of blockchain technologies, and in particular, to a blockchain balance adjusting method and device, and an electronic device.

### BACKGROUND

In related technologies, usually there is money transfer between users, between users and enterprises, and between enterprises. To implement money transfer between the payers and the payees, users or enterprises that pay money are payers, and users or enterprises that receive the money are payees.

When money transfer is implemented based on blockchain technologies, members of the blockchain deposit blockchain balances on anchor points, and these blockchain balances participate in money transfer processes related to corresponding members, to help implement money transfer between the payers and the payees.

### SUMMARY

In view of this, one or more implementations of present specification provide a blockchain balance adjusting method and device, and an electronic device.

To achieve the previous objective, one or more implementations of the present specification provide the following technical solutions:

According to a first aspect of one or more implementations of the present specification, a blockchain balance adjusting method is provided, including: querying, by at least one member, a blockchain balance deposited on at least one anchor point in a blockchain by the at least one member, and changes caused by transactions of blockchain balances deposited on the at least one anchor point by different members; and initiating, by the at least one member, a balance adjusting contract operation when a changed amount of the queried blockchain balance reaches a predetermined change threshold, to enable the changed amount to be less than the predetermined change threshold by adjusting the blockchain balance deposited on the at least one anchor point by the at least one member.

According to a second aspect of one or more implementations of the present specification, a blockchain balance adjusting method is provided, including: querying, by at least one member, a blockchain balance deposited on at least one anchor point in a blockchain by the at least one member, and changes caused by transactions of blockchain balances deposited on the at least one anchor point by different members; and initiating, by the at least one member, a balance adjusting contract operation when the blockchain balance deposited on the at least one anchor point by the at least one member is different from a specified amount, to adjust the blockchain balance deposited on the at least one anchor point by the at least one member to the specified amount.

According to a third aspect of one or more implementations of the present specification, a blockchain balance adjusting device is provided, including: a balance querying unit, enabling at least one member to query a blockchain balance deposited on at least one anchor point in a blockchain by the at least one member, and changes caused by transactions of blockchain balances deposited on the at least one anchor point by different members; and a balance adjusting unit, enabling the at least one member to initiate a balance adjusting contract operation when a changed amount of the queried blockchain balance reaches a predetermined change threshold, to enable the changed amount to be less than the predetermined change threshold by adjusting the blockchain balance deposited on the at least one anchor point by the at least one member.

According to a fourth aspect of one or more implementations of the present specification, a blockchain balance adjusting device is provided, including: a balance querying unit, enabling at least one member to query a blockchain balance deposited on at least one anchor point in a blockchain by the at least one member, and changes caused by transactions of blockchain balances deposited on the at least one anchor point by different members; and a balance adjusting unit, enabling the at least one member to initiate a balance adjusting contract operation when the blockchain balance deposited on the at least one anchor point by the at least one member is different from a specified amount, to adjust the blockchain balance deposited on the at least one anchor point by the at least one member to the specified amount.

According to a fifth aspect of one or more implementations of the present specification, an electronic device is provided, including: a processor; and a memory, configured to store an executable instruction of the processor, where the processor is configured to implement the blockchain balance adjusting method according to any one of the previous implementations.

### BRIEF DESCRIPTION OF DRAWINGS

FIG. 1A is a flowchart illustrating a blockchain balance adjusting method, according to an example implementation;

FIG. 1B is a flowchart illustrating another blockchain balance adjusting method, according to an example implementation;

FIG. 2 is a schematic diagram illustrating a remittance scenario, according to an example implementation;

FIG. 3 is a schematic interaction diagram in a cross-border remittance process, according to an example implementation;

FIG. 4 is a schematic diagram illustrating Wallet 1's acceptance of a remittance provided by user 1, according to an example implementation;

FIG. 5 is a schematic diagram illustrating determination of a remittance route, according to an example implementation;

FIG. 6 is a schematic diagram illustrating money transfer between members in a remittance route, according to an example implementation;

FIG. 7 is a schematic diagram illustrating provision of a remittance by Wallet 2 to user 2, according to an example implementation;

FIG. 8 is a schematic diagram illustrating transfer of a remittance into a blockchain balance, according to an example implementation;

FIG. 9 is a schematic diagram illustrating credit-based remittance, according to an example implementation;

FIG. 10 is a schematic diagram illustrating transaction information in a capital settlement, according to an example implementation;

FIG. 11 is a schematic diagram illustrating water-level restoration during capital settlement, according to an example implementation;

FIG. 12 is a schematic diagram illustrating water-level adjustment based on historical change data during capital settlement, according to an example implementation;

FIG. 13 is a schematic diagram illustrating water-level adjustment based on predicted data of transactions during capital settlement, according to an example implementation;

FIG. 14 is a schematic structural diagram illustrating a device, according to an example implementation;

FIG. 15 is a block diagram illustrating a blockchain balance adjusting device, according to an example implementation;

FIG. 16 is a block diagram illustrating another blockchain balance adjusting device, according to an example implementation; and

FIG. 17 is a flowchart illustrating an example of a computer-implemented method for adjusting blockchain balances, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with one or more implementations of the present specification. On the contrary, they are only examples of devices and methods that are described in the appended claims in detail and that are consistent with some aspects of one or more implementations of the present specification.

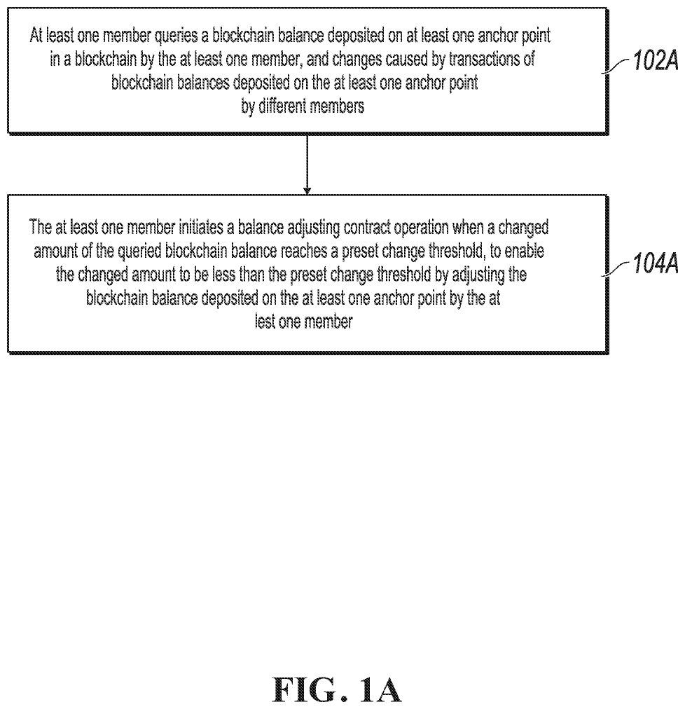

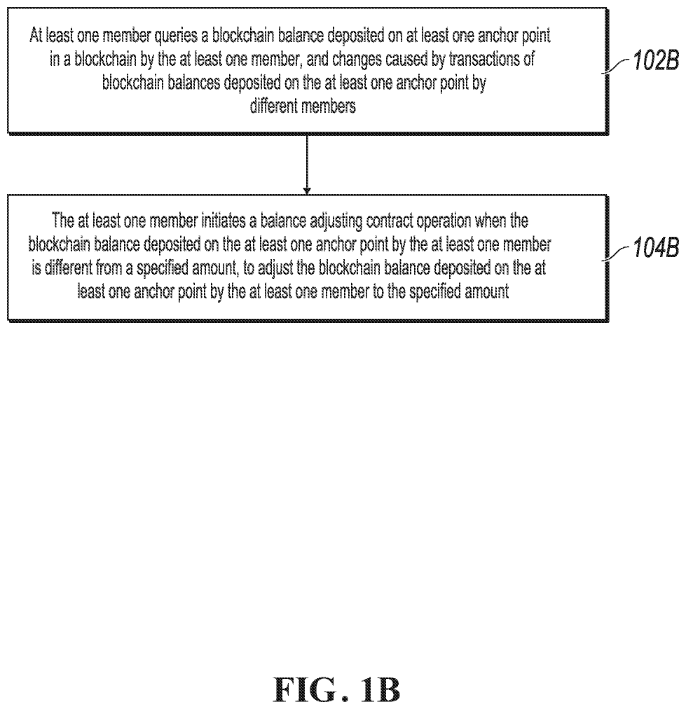

FIG. 1A is a flowchart illustrating a blockchain balance adjusting method, according to an example implementation. As shown in FIG. 1A, the method can include the following steps:

Step 102A. At least one member queries a blockchain balance deposited on at least one anchor point in a blockchain by the at least one member, and changes caused by transactions of blockchain balances deposited on the at least one anchor point by different members.

In an implementation, members can be financial institutions or other forms of organizations or platforms, which is not limited in present specification. A financial institution is used as an example, and different members can belong to different institutions (for example, a plurality of banks), or can belong to different branches of the same institution (for example, a plurality of branches of the same bank), which is not limited in present specification.

In an implementation, each member in the blockchain can deposit a certain amount of blockchain balance on each anchor point, and each anchor point is responsible for registering the blockchain balance of each member on the anchor point in the blockchain. Information recorded by the anchor point can be broadcast to all other nodes for storage. When any change in the blockchain balance occurs, the anchor point also records the corresponding change information in the blockchain and broadcasts it to all other nodes. The blockchain uses distributed accounting and all the nodes save full accounting information, and all nodes in the blockchain can become consistent by using a consensus algorithm to jointly maintain a uniform ledger, namely, a blockchain ledger. Therefore, in present specification, when a member or an anchor point reads or records information of the “blockchain ledger”, the member or the anchor point reads or records the full accounting information stored on the member or the anchor point.

In an implementation, several members of the blockchain join a smart contract (contract for short) for a money transfer service and authorize the contract, so these members can implement the money transfer service based on the contract. Each member can deposit a blockchain balance on each anchor point, and each anchor point can register ownership information of the deposited blockchain balance in the blockchain ledger, so the blockchain ledger records a blockchain balance of each member on each anchor point.

In an implementation, the at least one member can initiate a balance querying contract operation to query the blockchain balance deposited on the at least one anchor point in the blockchain by the at least one member. In other implementations, the at least one member can query the blockchain balance by using another method, which is not limited in present specification.

In an implementation, the at least one member queries the blockchain balance and adjusts the blockchain balance at the beginning or end of each settlement cycle (e.g., one day, three days, or one week, which is not limited in present specification) agreed by all members in the blockchain. In other implementations, the at least one member can also trigger querying and adjusting of the blockchain balance at any moment, which is not limited in present specification.

Step 104A. The at least one member initiates a balance adjusting contract operation when a changed amount of the queried blockchain balance reaches a predetermined change threshold, to enable the changed amount to be less than the predetermined change threshold by adjusting the blockchain balance deposited on the at least one anchor point by the at least one member.

In an implementation, the changed amount includes a net changed amount formed by transactions between the at least one member and the other members. For example, initially, the blockchain balance of the at least one member is RMB 1000, the first transaction with other members brings a decrease of RMB 200, and the second transaction brings an increase of RMB 50. As such, the changed amount is −200+50=−150, that is, the blockchain balance is reduced by RMB 150.

In an implementation, in addition to the blockchain balance registered initially, the blockchain ledger records information about transactions between members. Therefore, after the balance querying contract operation takes effect, the changed amount is determined based on information about transactions recorded in the blockchain ledger and between the at least one member and the other members. Because a characteristic of blockchain is that blockchain cannot be tampered with, the transaction information recorded in the blockchain ledger is reliable enough to reflect actual changes of the blockchain balance of the at least one member.

In an implementation, the at least one member can restore the blockchain balance deposited on the at least one anchor point to the amount before the change based on the changed amount and the balance adjusting contract operation. In other words, after the balance adjusting contract operation takes effect, the blockchain balance deposited on the at least one anchor point by the at least one member is adjusted to change the changed amount to 0. For example, when the blockchain balance is decreased (that is, the changed amount is a negative value; for example, RMB −200 represents a decrease of RMB 200), the blockchain balance can be restored as soon as possible to meet subsequent money transfer needs. When the blockchain balance is increased (that is, the changed amount is a positive value; for example, RMB 200 represents an increase of RMB 200), the blockchain balance is restored to meet subsequent money transfer needs, and the extra money can flow in other scenarios to avoid a waste of money arrangement.

In an implementation, the at least one member can adjust the predetermined change threshold based on historical change data of the blockchain balance deposited on the at least one anchor point by the at least one member. For example, the historical change data can include full historical change data, or historical change data of a specific time period (such as the current day, the recent three days, the latest week, and the fifth day of each month in the latest year, which is not limited in present specification), which is not limited in present specification. The at least one member can obtain corresponding historical change data from the blockchain ledger, and reliability and accuracy of the historical change data can be ensured. Based on the historical change data, the historical rule of the blockchain balance of the at least one member on the at least one anchor point can be determined. For example, when the historical actual changed amount of the blockchain balance is far less than the predetermined change threshold, the predetermined change threshold can be properly reduced so it approaches the historical actual changed amount (e.g., the historical maximum changed amount or the historical average changed amount). For another example, the predetermined change threshold can be kept unchanged when the historical actual changed amount of the blockchain balance is close to the predetermined change threshold, and the blockchain balance only needs to be restored to the predetermined change threshold.

In an implementation, the at least one member can adjust the predetermined change threshold based on predicted data of transactions between members in the blockchain. The predicted data of transactions indicates a future change trend of the blockchain balance, for example, can include entire-network transactions in the next day, or at least include changes of the blockchain balance of the at least one member in the next day, to help the at least one member adjust the predetermined change threshold. For example, when it is determined that a relatively large amount of money transfer can possibly occur in the entire network in the next day, the predetermined change threshold can be properly increased. In one case, the at least one member can obtain money transfer data, the blockchain balance, etc. of all members from the blockchain ledger, and generate the predicted data of transactions. In another case, the at least one member can obtain the predicted data of transactions from other members, anchor points, the blockchain, or any object, which is not limited in present specification.

In an implementation, the at least one member can adjust the predetermined change threshold based on both the historical change data of the blockchain balance deposited on the at least one anchor point by the at least one member, and the predicted data of transactions between the members in the blockchain, that is, the technical solutions in the previous two implementations are combined, and details are not omitted here for simplicity.

In an implementation, the at least one member adjusts, based on the balance adjusting contract operation, blockchain balances deposited on a plurality of anchor points by the at least one member when the at least one member separately deposits a blockchain balance on the plurality of anchor points in the blockchain.

In an implementation, the at least one member adjusts, based on the balance adjusting contract operation, an account owned by the member and the blockchain balance deposited on the at least one anchor point.

In an implementation, after the balance adjusting contract operation takes effect, the at least one anchor point is instructed to adjust, based on a credit of the at least one member, the blockchain balance deposited on the at least one anchor point by the at least one member.

FIG. 1B is a flowchart illustrating another blockchain balance adjusting method, according to an example implementation. As shown in FIG. 1B, the method can include the following steps:

Step 102B. At least one member queries a blockchain balance deposited on at least one anchor point in a blockchain by the at least one member, and changes caused by transactions of blockchain balances deposited on the at least one anchor point by different members.

In an implementation, members can be financial institutions or other forms of organizations or platforms, which is not limited in present specification. A financial institution is used as an example, and different members can belong to different institutions (for example, a plurality of banks), or can belong to different branches of the same institution (for example, a plurality of branches of the same bank), which is not limited in present specification.

In an implementation, each member in the blockchain can deposit a certain amount of blockchain balance on each anchor point, and each anchor point is responsible for registering the blockchain balance of each member on the anchor point in the blockchain. Information recorded by the anchor point can be broadcast to all other nodes for storage. When any change in the blockchain balance occurs, the anchor point also records the corresponding change information in the blockchain and broadcasts it to all other nodes. The blockchain uses distributed accounting and all the nodes save full accounting information, and all nodes in the blockchain can become consistent by using a consensus algorithm to jointly maintain a uniform ledger, namely, a blockchain ledger. Therefore, in present specification, when a member or an anchor point reads or records information of the “blockchain ledger”, the member or the anchor point reads or records the full accounting information stored on the member or the anchor point.

In an implementation, several members of the blockchain join a smart contract (contract for short) for a money transfer service and authorize the contract, so these members can implement the money transfer service based on the contract. Each member can deposit a blockchain balance on each anchor point, and each anchor point can register ownership information of the deposited blockchain balance in the blockchain ledger, so the blockchain ledger records a blockchain balance of each member on each anchor point.

In an implementation, the at least one member can initiate a balance querying contract operation to query the blockchain balance deposited on the at least one anchor point in the blockchain by the at least one member. In other implementations, the at least one member can query the blockchain balance by using another method, which is not limited in present specification.

In an implementation, the at least one member queries the blockchain balance and adjusts the blockchain balance at the beginning or end of each settlement cycle (e.g., one day, three days, or one week, which is not limited in present specification) agreed by all members in the blockchain. In other implementations, the at least one member can also trigger querying and adjusting of the blockchain balance at any moment, which is not limited in present specification.

Step 104B. The at least one member initiates a balance adjusting contract operation when the blockchain balance deposited on the at least one anchor point by the at least one member is different from a specified amount, to adjust the blockchain balance deposited on the at least one anchor point by the at least one member to the specified amount.

In an implementation, the at least one member can adjust the blockchain balance deposited on the at least one anchor point to the specified amount based on actual needs. For example, the specified amount can be an initial value before the blockchain balance deposited on the at least one anchor point by the at least one member is changed, so adjusting the blockchain balance to the specified amount is equivalent to restoring the blockchain balance to the initial value before the change. For another example, the specified amount can be an amount determined by the at least one member by using a certain method. As such, regardless of whether the blockchain balance deposited on the at least one anchor point by the at least one member is changed, if the blockchain balance is different from the specified amount, the blockchain balance can be adjusted to the specified amount.

The at least one member can determine the specified amount by using any method (including the previous method), which is not limited in present specification. The specified amount can be generated by the at least one member or can be obtained by the at least one member from other members.

In an implementation, the specified amount can be generated based on historical change data of the blockchain balance deposited on the at least one anchor point by the at least one member. For example, the historical change data can include full historical change data, or historical change data of a specific time period (such as the current day, the recent three days, the latest week, and the fifth day of each month in the latest year, which is not limited in present specification), which is not limited in present specification. The at least one member can obtain corresponding historical change data from the blockchain ledger, and reliability and accuracy of the historical change data can be ensured. Based on the historical change data, the historical rule of the blockchain balance of the at least one member on the at least one anchor point can be determined. For example, when the historical actual changed amount of the blockchain balance is far less than the initial value before the change, the specified amount can be set to be less than the initial value so it approaches the historical actual changed amount (e.g., the historical maximum changed amount or the historical average changed amount). For another example, the specified amount can be set to be equal to the initial value before the change when the historical actual changed amount of the blockchain balance is close to the initial value before the change, and the blockchain balance only needs to be restored to the initial value.

In an implementation, the specified amount can be determined by the at least one member based on predicted data of transactions between members in the blockchain. The predicted data of transactions indicates a future change trend of the blockchain balance, for example, can include entire-network transactions in the next day, or at least include changes of the blockchain balance of the at least one member in the next day, to help generate the specified amount. For example, when it is determined that a relatively large amount of money transfer can possibly occur in the entire network in the next day, the specified amount can be set to be greater than the initial value of the blockchain balance before the change. In one case, the at least one member can obtain money transfer data, the blockchain balance, etc. of all members from the blockchain ledger, and generate the predicted data of transactions. In another case, the at least one member can obtain the predicted data of transactions from other members, anchor points, the blockchain, or any object, which is not limited in present specification.

In an implementation, the at least one member can determine the specified amount based on both the historical change data of the blockchain balance deposited on the at least one anchor point by the at least one member, and the predicted data of transactions between the members in the blockchain, that is, the technical solutions in the previous two implementations are combined, and details are omitted here for simplicity.

In an implementation, the at least one member adjusts, based on the balance adjusting contract operation, blockchain balances deposited on a plurality of anchor points by the at least one member when the at least one member separately deposits a blockchain balance on the plurality of anchor points in the blockchain.

In an implementation, the at least one member adjusts, based on the balance adjusting contract operation, an account owned by the member and the blockchain balance deposited on the at least one anchor point.

In an implementation, after the balance adjusting contract operation takes effect, the at least one anchor point is instructed to adjust, based on a credit of the at least one member, the blockchain balance deposited on the at least one anchor point by the at least one member.

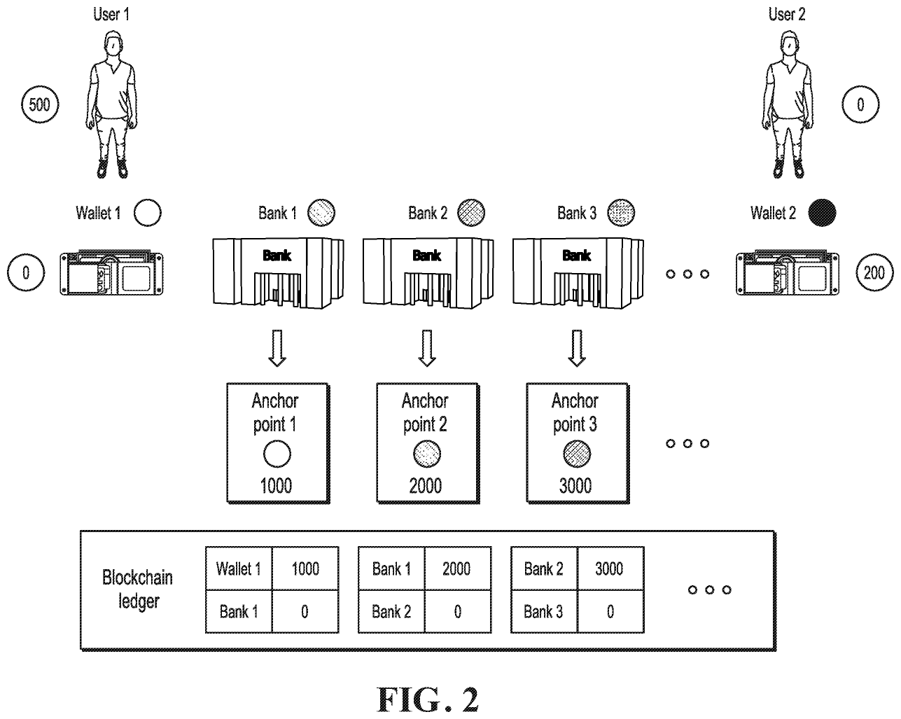

For ease of understanding, the following describes a technical solution of one or more implementations of present specification by using a “cross-border remittance” process as an example. FIG. 2 is a schematic diagram illustrating a remittance scenario, according to an example implementation. As shown in FIG. 2, assume that a third-party payment platform operates Wallet 1 in country A and operates Wallet 2 in country B. User 1 in country A has a customer account 1 in Wallet 1 and user 2 in country B has a customer account 2 in Wallet 2. A quick cross-border remittance can be implemented between user 1 and user 2 based on the money transfer method of present specification.

In an implementation, assume that Wallet 1, Wallet 2, Bank 1, Bank 2, Bank 3, etc. shown in FIG. 2 are members (member) in the same blockchain, and the blockchain can include several anchor points such as anchor point 1, anchor point 2, and anchor point 3 shown in FIG. 2. The role of the anchor point can be taken by the member. For example, anchor point 1 to anchor point 3 in FIG. 2 correspond to Bank 1 to Bank 3 respectively. Certainly, the member can be the anchor point or not, and the anchor point is not necessarily a member, that is, there is no one-to-one mapping relationship between members and anchor points. Members such as Wallets 1 and 2 and Banks 1 to 3, anchor points 1 to 3, etc. are nodes in the blockchain, and these nodes implement distributed accounting in the blockchain.

To implement a remittance between user 1 and user 2 by using each member in the blockchain, Wallets 1 and 2, Banks 1 to 3, etc. need to join a contract corresponding to the “remittance” service in advance, for example, here referred to as a remittance contract. Each member can deposit any amount of money on each anchor point, namely, a blockchain balance deposited on a corresponding anchor point by the member. For example, the blockchain balance deposited on anchor point 1 by Wallet 1 is RMB 1000, the blockchain balance deposited on anchor point 2 by Bank 1 is RMB 2000, and the blockchain balance deposited on anchor point 3 by Bank 2 is RMB 3000. Each member is subject to the remittance contract after joining the remittance contract, so the blockchain balance deposited on each anchor point by each member is registered by the corresponding anchor point in the blockchain ledger of the blockchain. A plurality of accounting nodes (usually greater than four) maintain a uniform distributed ledger of the blockchain. The ledger records the blockchain balance of each member on each anchor point. The accounting nodes enable ledger content on all nodes to be consistent, that is, be full accounting information of the blockchain, through broadcasting between nodes and a consensus algorithm. Therefore, all nodes in the blockchain can be considered to use the uniform ledger, namely, the blockchain ledger. Because the information in the blockchain cannot be tampered with and is traceable, the information registered in the blockchain ledger is reliable enough to be trusted by all members and anchor points, and can be used as an operation basis of various money transfer scenarios such as transfer and payment.

In addition, after joining the remittance contract, members record their trust level to each anchor point in the remittance contract for subsequent route determining. For example, as shown in FIG. 2, although Wallet 2 does not deposit a blockchain balance on anchor point 3, Wallet 2 sets anchor point 3 as a trusted anchor point, and the trust condition is represented by using “the blockchain balance is 0” in FIG. 2, indicating that Wallet 2 is willing to receive the blockchain balances that are sent by other members on anchor point 3. Anchor point 1 and anchor point 2 can be untrusted anchor points of Wallet 2, indicating that Wallet 2 is not willing to receive the blockchain balances that are sent by other members on anchor point 1 and anchor point 2.

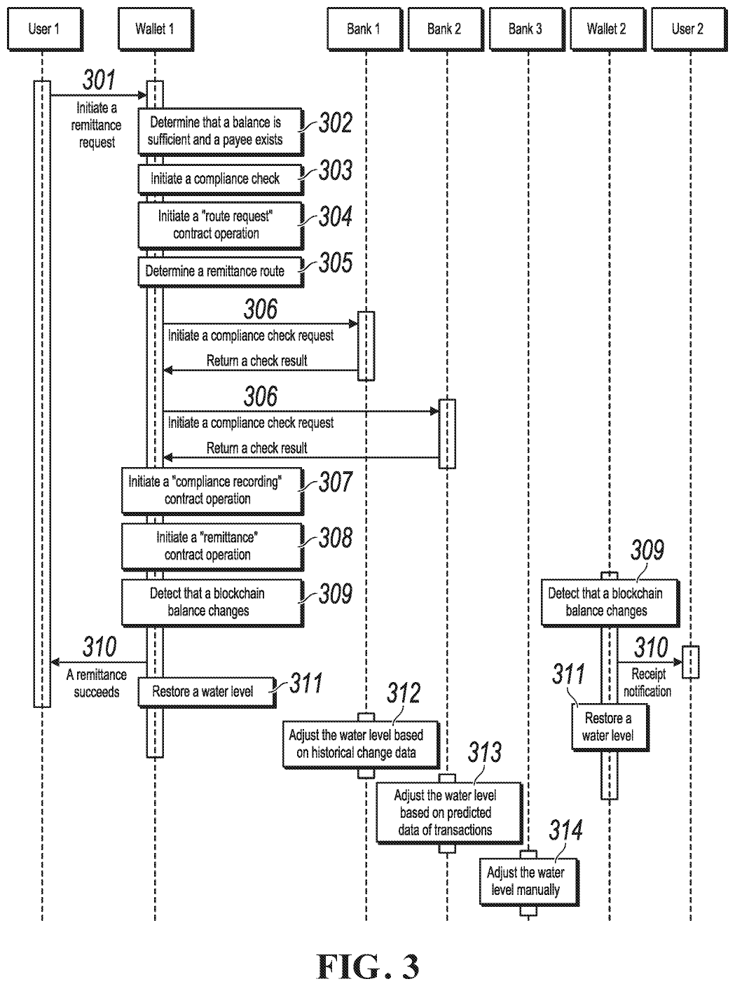

Based on the remittance scenario shown in FIG. 2, FIG. 3 is a schematic interaction diagram in a cross-border remittance process, according to an example implementation. As shown in FIG. 3, an interaction process between users 1 and 2, Wallets 1 and 2, Banks 1 to 3, and the blockchain can include the following steps:

Step 301: Wallet 1 receives a remittance request initiated by user 1.

In an implementation, user 1 can specify the remittance amount and the payee in the remittance request; for example, assume that user 1 sets the money amount to RMB 100 and the payee to user 2. In addition to initiating the remittance request by user 1, another method can be used to trigger the remittance process. For example, user 1 initiates a payment request of RMB 100 and payee is user 2. For another example, user 2 initiates a receiving request of RMB 100 and payer is user 1, which is not limited in present specification.

Step 302: Wallet 1 confirms that the balance in customer account 1 corresponding to user 1 is sufficient, and confirms, according to Wallet 2, that the payee user 2 exists.

In an implementation, FIG. 2 shows that customer account 1 corresponding to user 1 has a balance of RMB 500 greater than the needed RMB 100, and the balance is sufficient; or when the balance is less than the needed RMB 100, it indicates that the balance is insufficient, and Wallet 1 can directly terminate the remittance and return a remittance failure notification message to user 1.

In an implementation, Wallet 1 can send payee information to Wallet 2, and Wallet 2 determines whether the payee information is valid. The payee information can include the payee name, the payee account number, the deposit bank of the account, etc., which is not limited in present specification. After verifying the validity of the payee information, Wallet 2 can return a corresponding verification result to Wallet 1. When the payee does not exist, Wallet 1 can directly terminate the remittance and return a remittance failure notification message to user 1.

Step 303: Wallet 1 can perform compliance check on the remittance event initiated by user 1 to user 2.

In an implementation, Wallet 1 can provide a document submission entry to user 1, and user 1 provides to-be-checked documents for the remittance event. User 1 can submit static documents (such as the identity card photo of user 1) that can be used for all remittances in advance, and submit dynamic documents (such as recent remittance records) for a corresponding remittance event to improve remittance efficiency.

In an implementation, the compliance check on the remittance event by Wallet 1 can include at least one of Know Your Customer (KYC) check, Anti-Money Laundering (AML) check, and other types of check, which is not limited in present specification.

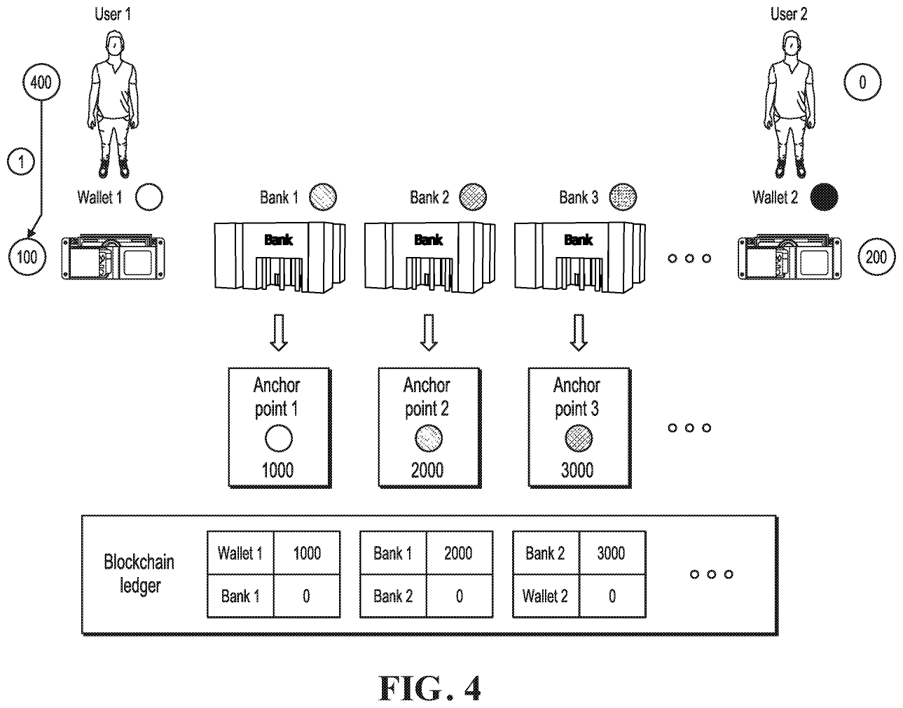

In an implementation, if the check result obtained by Wallet 1 is unqualified, Wallet 1 can directly terminate the remittance and return a remittance failure notification message to user 1. Or, Wallet 1 can provide user 1 with at least one opportunity for document supplement. For example, Wallet 1 can provide a maximum of two opportunities for user 1. If user 1 performs more than two times of document supplement and is still not qualified, Wallet 1 can terminate the remittance and return a remittance failure notification message to user 1. If the check result obtained by Wallet 1 is qualified, as shown in FIG. 4, Wallet 1 can deduct RMB 100 from customer account 1 corresponding to user 1 and transfer RMB 100 to self-owned account 1 of Wallet 1.

Step 304: Wallet 1 initiates a “routing request” contract operation.

Step 305: Wallet 1 determines a remittance route.

In an implementation, after joining the remittance contract, the members in the blockchain can invoke several contract operations supported by the remittance contract, for example, the “routing request” operation here. The contract operation is used to determine a remittance route of the remittance from user 1 to user 2 to implement a remittance operation.

In an implementation, the remittance route includes Wallet 1 as the most upstream member, Wallet 2 as the most downstream member, and several intermediate members between the two members. Based on the technical solutions in present specification, blockchain balances of members in the remittance route deposited on anchor points in the blockchain are transferred to present an effect of “the remittance (for example, RMB 100 that user 1 expects to remit) flows from Wallet 1 to Wallet 2”, and finally Wallet 2 provides the remittance to user 2.

When the remittance is transferred among the members in the remittance route, several times of money transfer may be obtained through division, such as money transfer between Wallet 1 and an intermediate member, money transfer between intermediate members, and money transfer between an intermediate member and Wallet 2. For example, when the remittance route is “Wallet 1-intermediate member 1-intermediate member 2-Wallet 2”, it includes three pairs of adjacent members: “Wallet 1-intermediate member 1”, “intermediate 1-intermediate member 2”, and “intermediate member 2-Wallet 2”, and involves three of money transfer: transfer from Wallet 1 to intermediate member 1, transfer from intermediate member 1 to intermediate member 2, and transfer from intermediate member 2 to Wallet 2. In each pair of adjacent members, an anchor point in the blockchain needs to implement the money transfer, and two conditions are involved: Condition (1). The blockchain balance deposited on a certain anchor point by the upstream member of the adjacent members is greater than the remittance amount; condition (2). The downstream member of the adjacent members sets the anchor point as a trusted anchor point. In other words, there is an associated anchor point between the upstream and downstream members, the upstream member has a sufficient blockchain balance on the associated anchor point for money transfer, and the downstream member is willing to receive the transferred blockchain money from the associated anchor point.

Wallet 1 can read the previous blockchain ledger based on the full accounting information stored in Wallet 1, learn of blockchain balances deposited on anchor points such as anchor point 1 to anchor point 3 by members such as banks 1 to 3, determine whether each member satisfies conditions (1) and (2) in combination with a trusted anchor point corresponding to each member recorded in the contract, and further determine the remittance route.

Wallet 1 and Bank 1 are used as an example: A blockchain balance deposited on anchor point 1 by Wallet 1 is RMB 1000, which is greater than the remittance amount of RMB 100, and Bank 1 sets anchor point 1 as a trusted anchor point. Therefore, anchor point 1 is an associated anchor point between Wallet 1 and Bank 1, and Wallet 1 and Bank 1 can implement money transfer based on anchor point 1.

Bank 1 and Bank 3 are used as an example: Bank 1 does not deposit any blockchain balance on anchor point 1 (because anchor point 1 is a trusted anchor point of Bank 1, it can be understood as that the blockchain balance is 0). Bank 1 deposits a blockchain balance of RMB 2000 on anchor point 2, which is greater than the remittance amount of RMB 100. But anchor point 2 is an untrusted anchor point set by Bank 3. Therefore, no associated anchor point exists between Bank 1 and Bank 3, and money transfer cannot be implemented. Bank 1 and Bank 2 are used as another example: Bank 1 deposits a blockchain balance of RMB 2000 on anchor point 2, which is greater than the remittance amount of RMB 100, and Bank 2 sets anchor point 2 as a trusted anchor point. Therefore, anchor point 2 is an associated anchor point between Bank 1 and Bank 2, and Bank 1 and Bank 2 can implement money transfer based on anchor point 2.

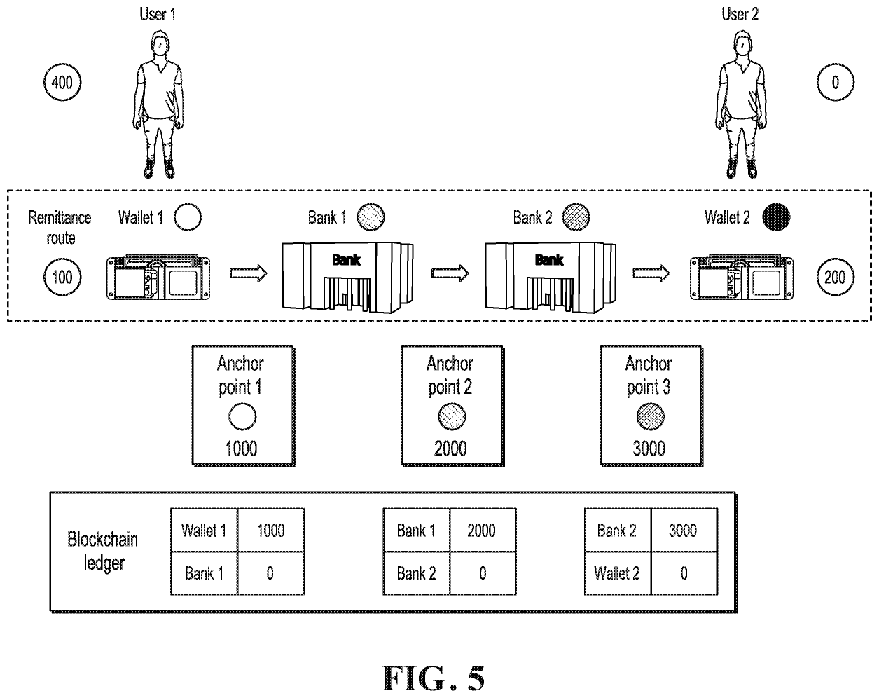

Similarly, whether members in the blockchain satisfy conditions (1) and (2) can be separately determined by using the previous method, and then determine the several intermediate members that can successively connect Wallet 1 and Wallet 2, and finally obtain the complete remittance route. For example, FIG. 5 is a schematic diagram illustrating determination of a remittance route, according to an example implementation. As shown in FIG. 5, the remittance route can include Wallet 1-Bank 1-Bank 2-Wallet 2, an associated anchor point between Wallet 1 and Bank 1 is anchor point 1, an associated anchor point between Bank 1 and Bank 2 is anchor point 2, and an associated anchor point between Bank 2 and Wallet 2 is anchor point 3.

In an implementation, Wallet 1 can determine a plurality of remittance routes at the same time, and select a final remittance route based on a specific condition. For example, the condition can include the shortest path and the lowest costs, which is not limited in present specification.

Step 306: Wallet 1 initiates a compliance check request for all intermediate members in the remittance route.

In an implementation, when Wallet 1 and Wallet 2 belong to the same third-party payment platform, because Wallet 1 has completed the compliance check in step 303, the check result is also applicable to Wallet 2, that is, Wallet 2 does not need to repeatedly perform the compliance check. In another implementation, Wallet 1 and Wallet 2 can belong to different third-party payment platforms, and Wallet 1 can initiate a compliance check request to all intermediate members and Wallet 2 in step 306, so the compliance check is performed on all intermediate members and Wallet 2. For ease of description, the following is described by using an example that the compliance check does not need to be individually performed on Wallet 2.

In an implementation, because compliance check methods used for the members are not the same, the compliance check needs to be individually performed on the to-be-checked documents of user 1. In addition, Wallet 1 simultaneously initiates the compliance check request to Bank 1 and Bank 2, so Bank 1 and Bank 2 can initiate the compliance check for the remittance event in parallel, instead of serial compliance check between the intermediate members. It reduces the time for performing the compliance check on the remittance event and improves efficiency of the compliance check.

In an implementation, Wallet 1 can push the to-be-checked documents provided by user 1 to Bank 1 and Bank 2, so the compliance check is performed based on the to-be-checked documents, for example, the previous KYC check and AML check. To ensure integrity and reliability of the to-be-checked documents in the push process, Wallet 1 can generate a digital digest corresponding to the to-be-checked documents before the push and record the digital digest in the blockchain by invoking the “document recording” contract operation. After receiving the pushed to-be-checked documents, Bank 1 and Bank 2 can read the digital digest from the blockchain and check the digital digest with the digital digest of the received to-be-checked documents. If the digital digests are the same, it is confirmed that the to-be-checked documents are complete and reliable. Otherwise, the to-be-checked documents are inaccurate and need to be provided again by Wallet 1.

In an implementation, after the compliance check is completed, any member in the remittance route can return a corresponding check result to Wallet 1. The check result can include a digital digest corresponding to detailed data of the compliance check of the member, a determining result (qualified or unqualified), and signature information of the member (indicating that the check result comes from the member). The detailed data corresponding to the digital digest included in the check result is related to the privacy information of user 1, user 2, etc., and the non-disclosure rule of the compliance check of the member. Therefore, the check result includes only the digital digest, and the detailed data is only recorded on the member and is provided for subsequent verification or inspection by the regulatory department.

It is worthwhile to note that the compliance check performed by the intermediate members in step 306 is more important and necessary than that performed by Wallet 1 in step 303. In some scenarios, the compliance check performed by Wallet 1 in step 303 can even be omitted, but the compliance check performed by the intermediate members in step 306 is always necessary.

Step 307: Wallet 1 initiates a “compliance recording” contract operation to record an obtained check result in the blockchain ledger.

In an implementation, by initiating the “compliance recording” contract operation, Wallet 1 can record the check results returned by Bank 1 and Bank 2 in a block corresponding to Wallet 1, and further broadcast the check results to other nodes in the blockchain for recording. In other words, Wallet 1 records the check results in the previous described blockchain ledger. The blockchain cannot be tampered with and is traceable, so the check results are reliable enough to be withdrew and viewed by the regulatory department.

Similarly, for the check result obtained in step 303, Wallet 1 can also record the check result in the blockchain ledger by initiating the “compliance recording” contract operation for subsequent recall and reviewing.

In an implementation, when the check result returned by any member is not qualified, Wallet 1 can provide user 1 with at least one opportunity for document supplement. After obtaining the supplementary document, Wallet 1 can provide the supplementary document to the member so the member re-implements the compliance check. Wallet 1 can record the digital digest of the supplementary document in the blockchain ledger, so the member compares the digital digest of the received supplementary document with the digital digest recorded in the blockchain ledger, to determine whether the received supplementary document is reliable. Assume that Wallet 1 can provide a maximum of two opportunities to user 1. If user 1 implements more than two times of document supplement and the check result returned by the member is still not qualified, Wallet 1 can terminate the remittance and return a remittance failure notification message to user 1.

In an implementation, after Wallet 1 initiates the compliance check request to Bank 1 and Bank 2, if returned check results are not received within predetermined duration (for example, two minutes), it can be determined that the check results are unqualified. As such, on one hand, the “unqualified” check results are recorded in the blockchain ledger by invoking the “compliance recording” contract operation, and on the other hand, the remittance is terminated and a remittance failure notification message is returned to user 1.

Step 308: When the compliance check results of Bank 1 and Bank 2 are qualified, Wallet 1 initiates a remittance contract operation to implement money transfer between the members in the remittance route.

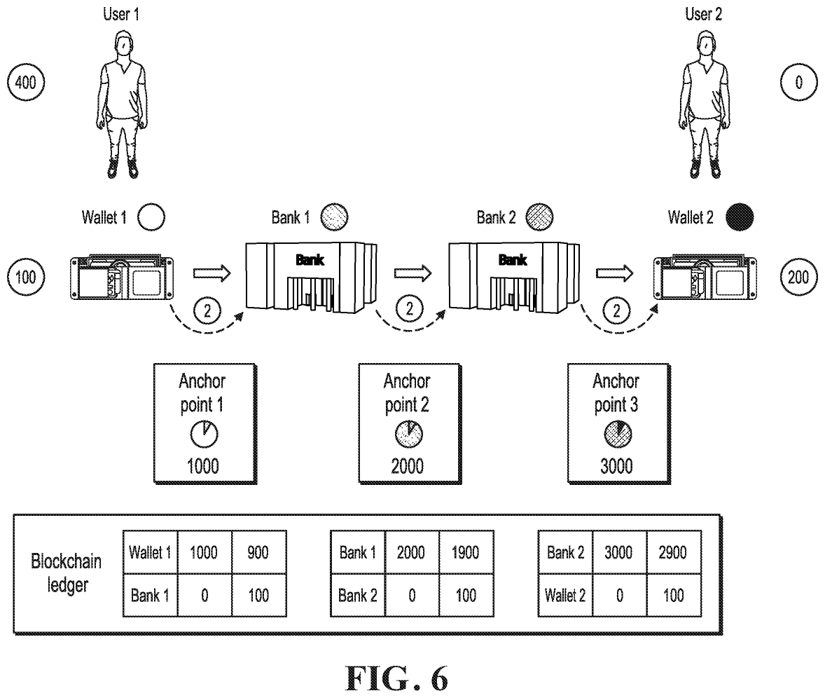

In an implementation, before the remittance contract operation takes effect, the blockchain ledger records the blockchain balance shown in FIG. 5, including the blockchain balance RMB 1000 deposited on anchor point 1 by Wallet 1, the blockchain balance RMB 2000 deposited on anchor point 2 by Bank 1, and the blockchain balance RMB 3000 deposited on anchor point 3 by Bank 2. After the remittance contract operation takes effect, money transfer is successively implemented among Wallet 1, Bank 1, Bank 2, and Wallet 2 in the remittance route, as shown in FIG. 6.

The money transfer is implemented between Wallet 1 and Bank 1 through anchor point 1. The blockchain balance deposited on anchor point 1 by Wallet 1 transfers RMB 100 to the blockchain balance deposited on anchor point 1 by Bank 1, so the blockchain balance deposited on anchor point 1 by Wallet 1 decreases from RMB 1000 to RMB 900, and the blockchain balance deposited on anchor point 1 by Bank 1 increases from RMB 0 to RMB 100.

The money transfer is implemented between Bank 1 and Bank 2 through anchor point 2. The blockchain balance deposited on anchor point 2 by Bank 1 transfers RMB 100 to the blockchain balance deposited on anchor point 2 by Bank 2, so the blockchain balance deposited on anchor point 2 by Bank 1 decreases from RMB 2000 to RMB 1900, and the blockchain balance deposited on anchor point 2 by Bank 2 increases from RMB 0 to RMB 100.

The money transfer is implemented between Bank 2 and Wallet 2 through anchor point 3. The blockchain balance deposited on anchor point 3 by Bank 2 transfers RMB 100 to the blockchain balance deposited on anchor point 3 by Wallet 2, so the blockchain balance deposited on anchor point 3 by Bank 2 decreases from RMB 3000 to RMB 2900, and the blockchain balance deposited on anchor point 3 by Wallet 2 increases from RMB 0 to RMB 100.

In the money transfer processes between Wallet 1 and Bank 1, Bank 1 and Bank 2, Bank 2 and Wallet 2, because self-owned account 1 of Wallet 1 increases by RMB 100 transferred from customer account 1 of user 1 and the blockchain balance deposited on anchor point 1 by Wallet 1 decreases by RMB 100, the net money transfer of Wallet 1 is RMB 0; because the blockchain balance deposited on anchor point 1 by Bank 1 increases by RMB 100 and the blockchain balance deposited on anchor point 2 by Bank 1 decreases by RMB 100, the net money transfer of Bank 1 is RMB 0; because the blockchain balance deposited on anchor point 2 by Bank 2 increases by RMB 100 and the blockchain balance deposited on anchor point 3 by Bank 2 decreases by RMB 100, the net money transfer of Bank 2 is RMB 0; because the blockchain balance deposited on anchor point 3 by Wallet 2 increases by RMB 100, it is equivalent to that RMB 100 remitted by user 1 is transferred to the blockchain balance of Wallet 2 through the remittance route.

It is worthwhile to note that all nodes in the blockchain use the uniform blockchain ledger, that is, the blockchain ledger records the blockchain balances deposited on all anchor points by all members, so the blockchain can uniformly adjust the blockchain balance deposited on anchor point 1 by Wallet 1, the blockchain balances deposited on anchor point 1 and anchor point 2 by Bank 1, the blockchain balances deposited on anchor point 2 and anchor point 3 by Bank 2, and the blockchain balance deposited on anchor point 3 by Wallet 2. As such, at the same time, the blockchain balance of Wallet 1 decreases by RMB 100, the blockchain balance of Wallet 2 increases by RMB 100, and the blockchain balances of the intermediate members do not change.

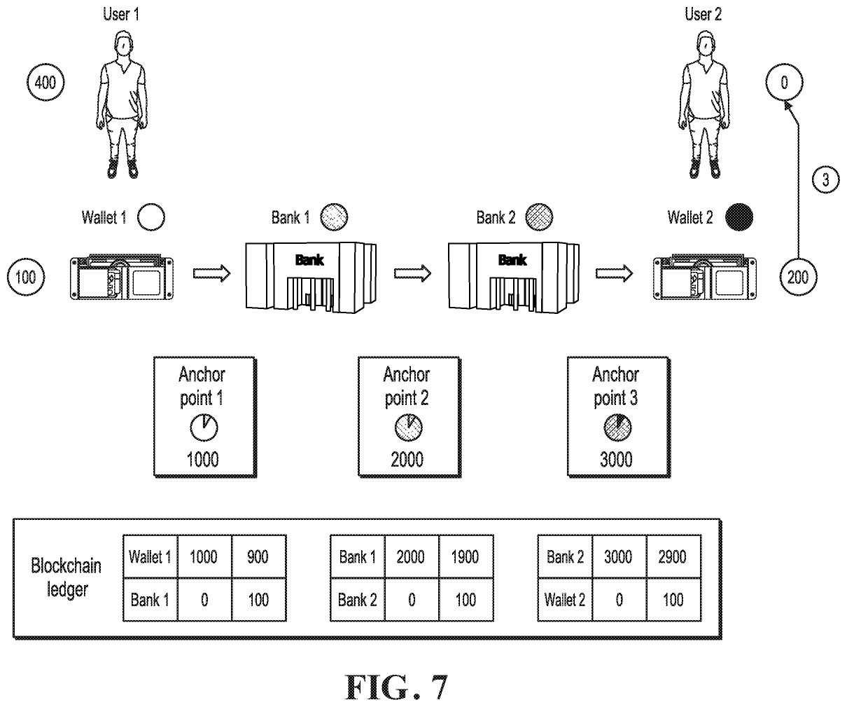

Therefore, as shown in FIG. 7, Wallet 2 can transfer RMB 100 from self-owned account 2 to customer account 2 of user 2. In combination with the increase of RMB 100 in the blockchain balance deposited on anchor point 3 by Wallet 2, it is equivalent to that the net money transfer of Wallet 2 is RMB 0 and user 2 obtains the remittance RMB 100 from user 1.

Step 309: Wallet 1 and Wallet 2 separately detect changes of the blockchain balances.

Step 310: Wallet 1 sends a remittance success notification to user 1, and Wallet 2 sends a receipt notification to user 2.

It is worthwhile to note that, in the previous implementation, Wallet 1 has self-owned account 1 and Wallet 2 has self-owned account 2. Wallet 1 performs money transfer with customer account 1 of user 1 through self-owned account 1 to obtain the remittance provided by user 1, and Wallet 2 performs money transfer with customer account 2 of user 2 through self-owned account 2 to provide the remittance to user 2. The blockchain balances of Wallet 1 and Wallet 2 change separately provided that the net money transfer between the self-owned accounts and the blockchain balances is 0. In other implementations, other processing methods exist, and examples are as follows:

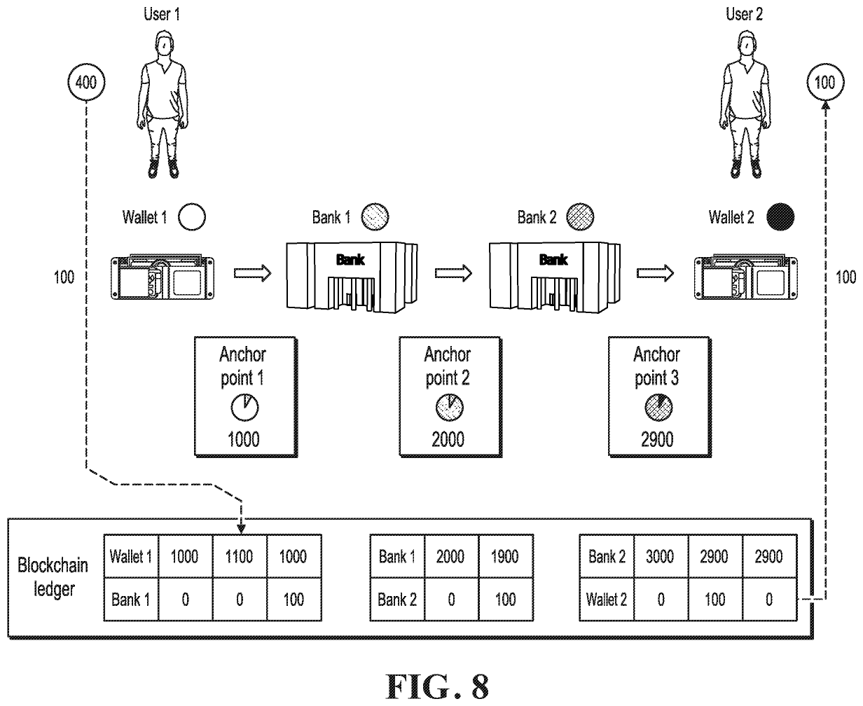

FIG. 8 is a schematic diagram illustrating transfer of a remittance into a blockchain balance, according to an example implementation. As shown in FIG. 8, based on change information of blockchain balances recorded in the blockchain ledger, the blockchain balance deposited on anchor point 1 by Wallet 1 is initially RMB 1000. After user 1 initiates a remittance request to user 2, Wallet 1 withdraws RMB 100 from customer account 1 corresponding to user 1 and deposits the RMB 100 to the blockchain balance deposited on anchor point 1 by Wallet 1, so the blockchain balance deposited on anchor point 1 by Wallet 1 increases to RMB 1100. Then, when Wallet 1 invokes a remittance contract operation, the blockchain balance deposited on anchor point 1 by Wallet 1 decreases from RMB 1100 to RMB 1000, and the blockchain balance deposited on anchor point 1 by Bank 1 increases from RMB 0 to RMB 100. In addition, the RMB 100 is successively transferred among Bank 1, Bank 2, and Wallet 2 like the implementation shown in FIG. 7, so the blockchain balance deposited on anchor point 3 by Wallet 2 increases from RMB 0 to RMB 100. Finally, Wallet 2 withdraws RMB 100 deposited on anchor point 3 and transfers the RMB 100 to customer account 2 of user 2, so user 1 completes the remittance to user 2. Based on the previous process, Wallet 1 and Wallet 2 do not need to have self-owned account 1 and self-owned account 2, but the money provided by user 1 is directly deposited into the blockchain balance to participate in the money transfer in the blockchain.

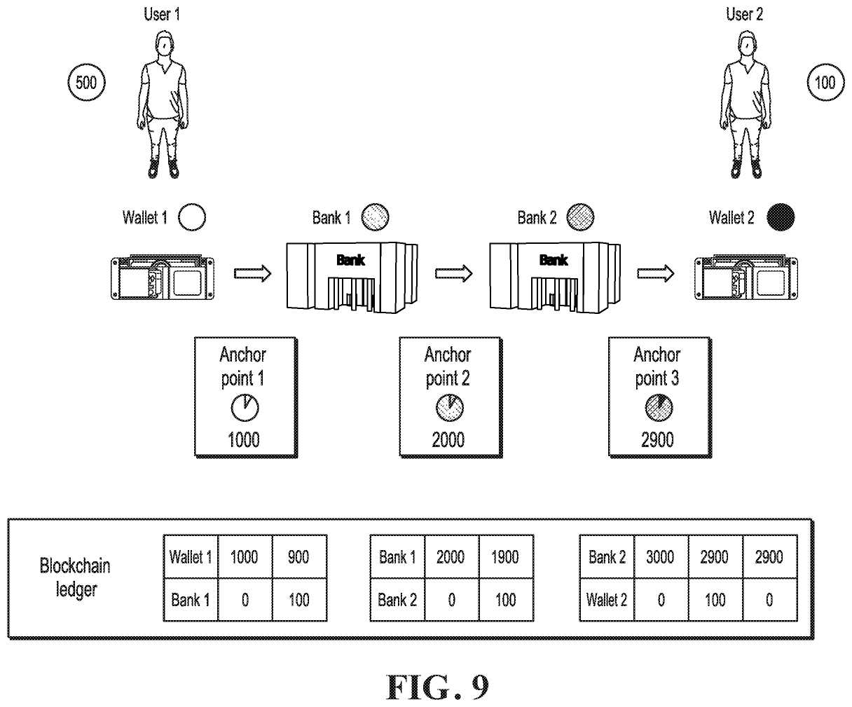

FIG. 9 is a schematic diagram illustrating credit-based remittance, according to an example implementation. As shown in FIG. 9, based on change information of blockchain balances recorded in the blockchain ledger, the blockchain balance deposited on anchor point 1 by Wallet 1 is initially RMB 1000. After user 1 initiates a remittance request to user 2, Wallet 1 can pay the money for the remittance operation of user 1 based on Wallet 1's credit to user 1, and user 1 subsequently returns the money. Therefore, based on money transfer among Wallet 1, Bank 1, Bank 2, and Wallet 2, the blockchain balance deposited on anchor point 1 by Wallet 1 decreases from RMB 1000 to RMB 900, the net money transfer is a decrease of RMB 100, and the net money transfer of Bank 1, Bank 2, and Wallet 2 is RMB 0. For the detailed money transfer process, reference may be made to the previous implementations. Details are omitted here for simplicity.

Step 311: After daily settlement, Wallet 1 and Wallet 2 restore water levels of blockchain balances deposited on each anchor point by themselves.

In an implementation, each member of the blockchain performs capital settlement based on a predetermined period, for example, the predetermined period can be one day, three days, one week, etc., which is not limited in present specification. For example, when the predetermined period is one day, each member performs capital settlement at a specific moment (for example, 18:00) each day, that is, daily settlement. The blockchain balance changes with transactions, just like the water level in a bucket. Therefore, adjustment to the blockchain balance can be vividly referred to as adjustment to the “water level”.

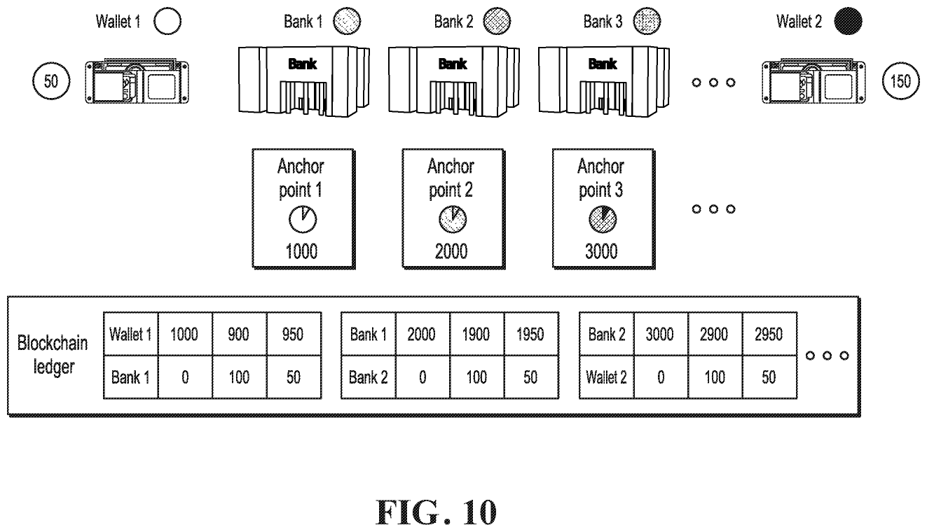

For example, FIG. 10 is a schematic diagram illustrating transaction information during capital settlement, according to an example implementation. As shown in FIG. 10, assume that Wallet s 1 and 2 and banks 1 to 3 participate in two transactions in total in one day. The first transaction is that user 1 remits RMB 100 to user 2, and the second transaction is that user 2 remits RMB 50 to user 1. As such, during settlement, it can be determined that the blockchain balance deposited on anchor point 1 by Wallet 1 becomes RMB 950, the blockchain balance deposited on anchor point 1 by Bank 1 is RMB 50, the blockchain balance deposited on anchor point 2 by Bank 1 is RMB 1950, the blockchain balance deposited on anchor point 2 by Bank 2 is RMB 50, the blockchain balance deposited on anchor point 3 by Bank 2 is RMB 2950, and the blockchain balance deposited on anchor point 3 by Wallet 2 is RMB 50.

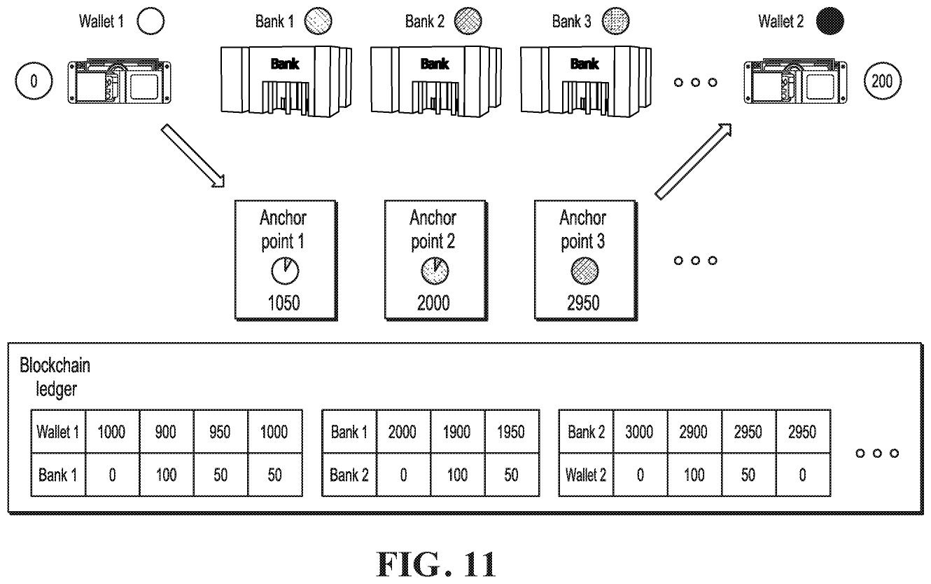

Based on information about the transactions between the members recorded in the blockchain ledger, it can be determined that the blockchain balance deposited on anchor point 1 by Wallet 1 changes from RMB 1000 to RMB 900 and from RMB 900 to RMB 950, and therefore the net money transfer is 950−1000=−50, that is, a decrease of RMB 50. As such, Wallet 1 can deposit RMB 50 from self-owned account 1 to the blockchain balance deposited on anchor point 1 (the balance of self-owned account 1 accordingly decreases from RMB 50 to RMB 0), so the blockchain balance restores from RMB 950 to RMB 1000. The change information of the blockchain balance is registered by anchor point 1 in the blockchain ledger. Details are shown in FIG. 11. Wallet 1 can deposit RMB 50 from self-owned account 1 to the blockchain balance deposited on anchor point 1 by initiating a money depositing contract operation.

Similarly, based on information about the transactions between the members recorded in the blockchain ledger, it can be determined that the blockchain balance deposited on anchor point 3 by Wallet 2 changes from RMB 0 to RMB 100 and from RMB 100 to RMB 50, and therefore the net money transfer is 50−0=50, that is, an increase of RMB 50. As such, Wallet 2 can withdraw RMB 50 from the blockchain balance deposited on anchor point 3 to self-owned account 2 (the balance of self-owned account 2 accordingly increases from RMB 150 to RMB 200), so the blockchain balance restores from RMB 50 to RMB 0. The change information of the blockchain balance is registered by anchor point 3 in the blockchain ledger. Details are shown in FIG. 11. Wallet 2 can withdraw RMB 50 from the blockchain balance deposited on anchor point 3 to self-owned account 2 by initiating a money withdraw contract operation.

Step 312: Adjust the water level of the blockchain balance of Bank 1 based on historical change data.

In an implementation, Bank 1 can read all transactions related to Bank 1 from the blockchain ledger to obtain the historical change data of Bank 1. Therefore, Bank 1 can predict changes of the blockchain balance on each anchor point in the next day based on full historical change data or historical change data of a specific time period (for example, the recent three days, the latest week, or Mondays of the recent five weeks) to adjust the water level of the blockchain balance.

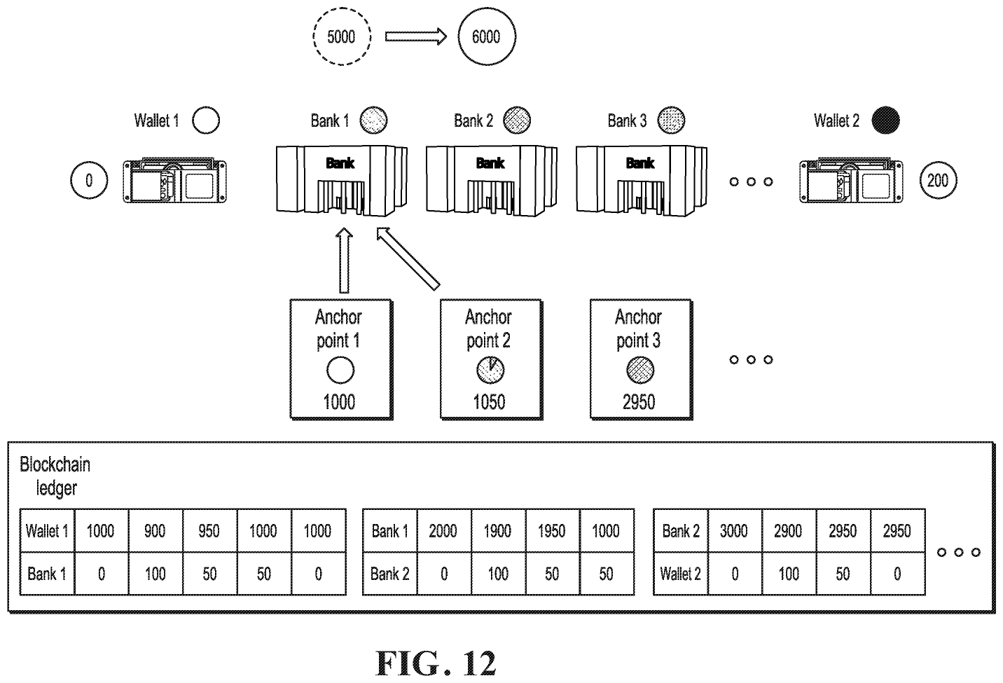

For example, when the historical change data indicates that the net changed amount does not exceed RMB 100 when the initial amount of the blockchain balance of Bank 1 on anchor point 1 is RMB 0, and the net changed amount does not exceed RMB 1000 when the initial amount of the blockchain balance of Bank 1 on anchor point 2 is RMB 2000, as shown in FIG. 12, because the initial amount RMB 0 on anchor point 1 has a small difference from the amount RMB 100, the blockchain balance RMB 0 of Bank 1 on anchor point 1 can be kept. As such, it is necessary to withdraw RMB 50 from the blockchain balance deposited on anchor point 1 to self-owned account of Bank 1, so the blockchain balance of Bank 1 on anchor point 1 restores to RMB 0. For example, Bank 1 can initiate the money withdraw contract operation to withdraw RMB 50 from the blockchain balance deposited on anchor point 1 to self-owned account of Bank 1. Because the initial amount RMB 2000 on anchor point 2 has a big difference from the amount RMB 1000, the blockchain balance of Bank 1 on anchor point 2 can be adjusted to RMB 1000. Therefore, it is necessary to withdraw RMB 950 from the blockchain balance deposited on anchor point 2 to self-owned account of Bank 1, so the blockchain balance of Bank 1 on anchor point 2 is decreased to RMB 1000. For example, Bank 1 can initiate the money withdraw contract operation to withdraw RMB 950 from the blockchain balance deposited on anchor point 2 to self-owned account of Bank 1.

It can be seen from the implementations shown in FIG. 11 and FIG. 12 that, in the water level adjustment process, adjustment can be performed between the blockchain balance and a self-owned account of the member.

Step 313: Adjust the water level of the blockchain balance of Bank 2 based on predicted data of transactions.

In an implementation, Bank 2 can read information such as all transactions occurring in the entire network from the blockchain ledger and generate corresponding predicted data of transactions based on the information. For example, the predicted data includes entire-network transactions in the next day or at least includes changes of the blockchain balance of Bank 2 in the next day, so Bank 2 adjusts the water level of the blockchain balance accordingly. Certainly, instead of only generated by Bank 2, the predicted data of transactions can come from other members, anchor points, the blockchain, or any object, which is not limited in present specification.

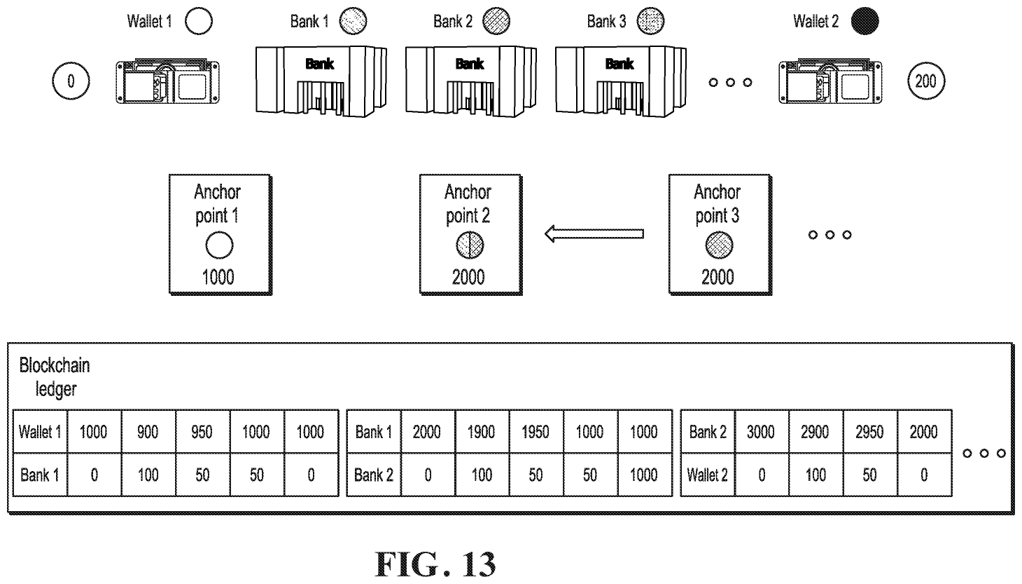

For example, as shown in FIG. 13, assume that Bank 2 predicts that the net changed amount on anchor point 2 in the next day approaches RMB 1000 and the net changed amount on anchor point 3 is less than RMB 2000. As such, Bank 2 can transfer RMB 950 from the blockchain balance deposited on anchor point 3 to the blockchain balance deposited on anchor point 2. For example, Bank 2 can initiate the money withdraw contract operation to withdraw RMB 950 from the blockchain balance deposited on anchor point 3, and initiate the money depositing contract operation to deposit RMB 950 to the blockchain balance deposited on anchor point 2. So the blockchain balance deposited on anchor point 2 increases to RMB 1000 and the blockchain balance deposited on anchor point 3 decreases to RMB 2000, satisfying predicted money change needs on anchor points 2 and 3 in the next day.

It can be seen from the implementation shown in FIG. 13 that, in the water level adjustment process, adjustment can be performed between blockchain balances on a plurality of anchor points.

Step 314: Manually adjust the blockchain balance of Bank 3.

In an implementation, each member can perform water level adjustment by using any solution or a combination of the water level restoration, water level adjustment based on the historical change data, water level adjustment based on the predicted data of transactions, and the manual water level adjustment (for example, blockchain balances on some anchor points use the water level restoration solution, and blockchain balances on other anchor points perform water level adjustment based on the historical change data), which is not limited in present specification.

In an implementation, the member can adjust the water level of the blockchain balance on each anchor point by invoking a “balance adjusting” contract operation. The “balance adjusting” contract operation can include the previously described money depositing contract operation, money withdraw contract operation, etc. In addition to adjustment between blockchain balances and adjustment between the blockchain balance and the self-owned account, if a member obtains a credit on an anchor point, the “balance adjusting” contract operation can instruct the anchor point to adjust based on the credit the blockchain balance deposited by the member (that is, the changes of the blockchain balance are recorded in the blockchain ledger).

It is worthwhile to note that there can be a plurality of types of blockchains in present specification, and present specification is not limited thereto. For example, when the blockchain is a consortium chain, each member in the remittance route is a member of the consortium chain to ensure that the member has a corresponding operation right.

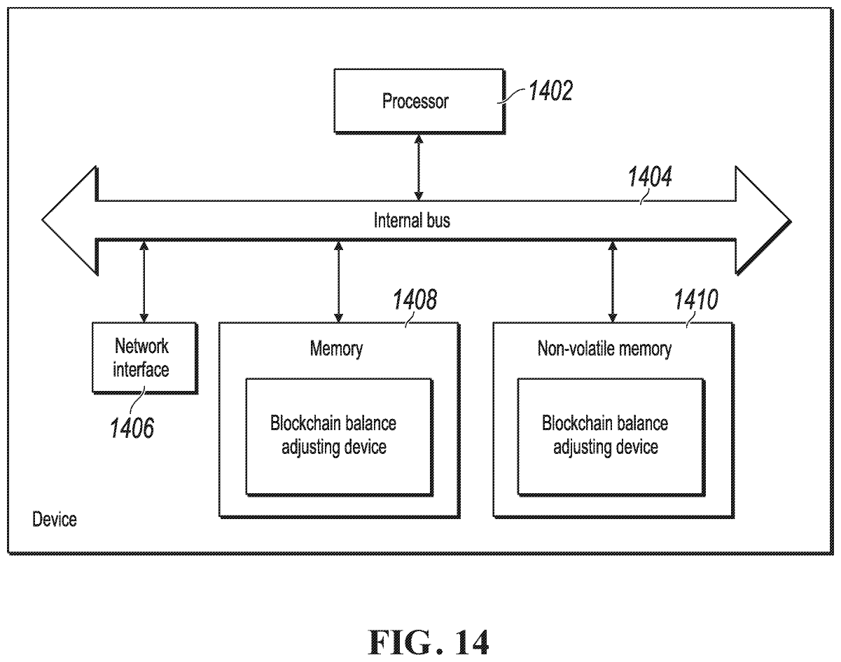

FIG. 14 is a schematic structural diagram illustrating a device, according to an example implementation. As shown in FIG. 14, in terms of hardware, the device includes a processor 1402, an internal bus 1404, a network interface 1406, a memory 1408, and a non-volatile memory 1410, and certainly can further include hardware needed by other services. The processor 1402 reads corresponding computer programs from the non-volatile memory 1410 into the memory 1408 and then runs the corresponding computer programs, to form a blockchain balance adjusting device in terms of logic. Certainly, in addition to a software implementation, one or more implementations of present specification do not exclude other implementations, for example, a logic device or a combination of hardware and software. That is, an execution body of the following processing procedure is not limited to each logical unit, and can also be hardware or a logic device.

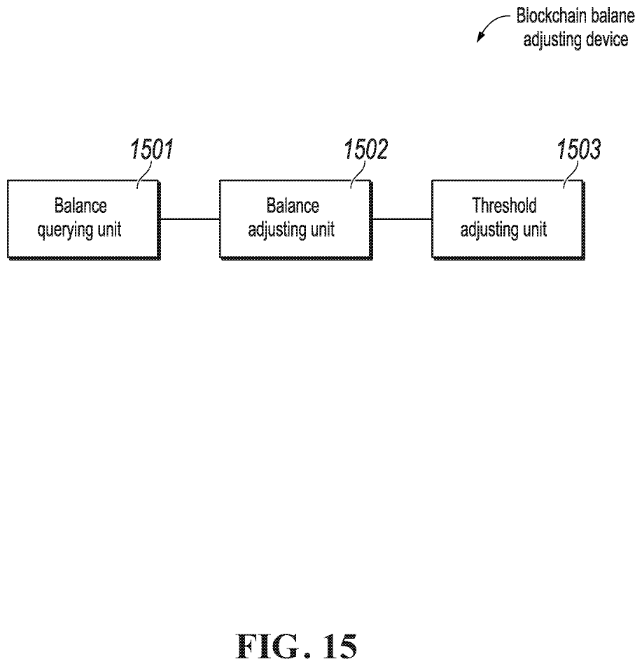

In an implementation, referring to FIG. 15, in a software implementation, the blockchain balance adjusting device can include: a balance querying unit 1501, enabling at least one member to query a blockchain balance deposited on at least one anchor point in a blockchain by the at least one member, and changes caused by transactions of blockchain balances deposited on the at least one anchor point by different members; and a balance adjusting unit 1502, enabling the at least one member to initiate a balance adjusting contract operation when a changed amount of the queried blockchain balance reaches a predetermined change threshold, to enable the changed amount to be less than the predetermined change threshold by adjusting the blockchain balance deposited on the at least one anchor point by the at least one member.

Optionally, the balance querying unit 1501 is configured to enable the at least one member to initiate a balance querying contract operation to query the blockchain balance deposited on the at least one anchor point in the blockchain by the at least one member.

Optionally, a blockchain ledger of the blockchain records information about transactions between members, and the changed amount is determined based on information about transactions recorded in the blockchain ledger and between the at least one member and the other members.

Optionally, the changed amount includes a net changed amount formed by transactions between the at least one member and the other members.

Optionally, the balance querying unit 1501 is configured to enable the at least one member to query the blockchain balance deposited on the at least one anchor point in the blockchain by the at least one member at, the beginning or end of each settlement cycle agreed by all members in the blockchain.

Optionally, after the balance adjusting contract operation takes effect, the blockchain balance deposited on the at least one anchor point by the at least one member is adjusted so the changed amount is 0.

Optionally, the device further includes: a threshold adjusting unit 1503, enabling the at least one member to adjust the predetermined change threshold based on historical change data of the blockchain balance deposited on the at least one anchor point by the at least one member and/or predicted data of transactions between members in the blockchain.

Optionally, the balance adjusting unit 1502 is configured to enable the at least one member to adjust, based on the balance adjusting contract operation, blockchain balances deposited on a plurality of anchor points by the at least one member when the at least one member separately deposits a blockchain balance on the plurality of anchor points in the blockchain.

Optionally, the balance adjusting unit 1502 is configured to enable the at least one member to adjust, based on the balance adjusting contract operation, an account owned by the member and the blockchain balance deposited on the at least one anchor point.

Optionally, after the balance adjusting contract operation takes effect, the at least one anchor point is instructed to adjust, based on a credit of the at least one member, the blockchain balance deposited on the at least one anchor point by the at least one member.

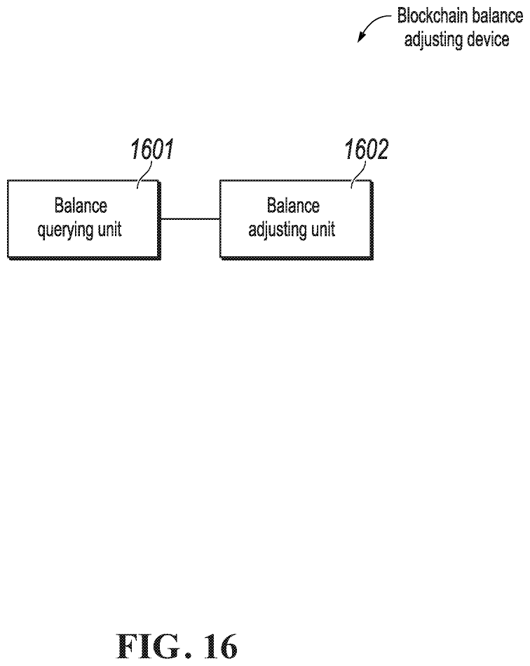

In another implementation, referring to FIG. 16, in a software implementation, the blockchain balance adjusting device can include: a balance querying unit 1601, enabling at least one member to query a blockchain balance deposited on at least one anchor point in a blockchain by the at least one member, and changes caused by transactions of blockchain balances deposited on the at least one anchor point by different members; and a balance adjusting unit 1602, enabling the at least one member to initiate a balance adjusting contract operation when the blockchain balance deposited on the at least one anchor point by the at least one member is different from a specified amount, to adjust the blockchain balance deposited on the at least one anchor point by the at least one member to the specified amount.

Optionally, the specified amount is determined through analysis by the at least one member based on at least one of the following data: historical change data of the blockchain balance deposited on the at least one anchor point by the at least one member and predicted data of transactions between members in the blockchain.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, an intelligent phone, a personal digital assistant, a media player, a navigation device, an email receiving and sending device, a game console, a tablet computer, a wearable device, or any combination of these devices.

In a typical configuration, a computer includes one or more processors (CPU), an input/output interface, a network interface, and a memory.

The memory can include a non-persistent memory, a random access memory (RAM), a non-volatile memory, and/or another form in a computer readable medium, for example, a read-only memory (ROM) or a flash memory (flash RAM). The memory is an example of the computer readable medium.

The computer readable medium includes persistent, non-persistent, movable, and unmovable media that can implement information storage by using any method or technology. Information can be a computer readable instruction, a data structure, a program module, or other data. A computer storage medium includes but is not limited to a phase-change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a magnetic tape, a magnetic disk storage, a quantum storage, a graphene-based storage medium, another magnetic storage device, or any other non-transmission medium. The computer storage medium can be used to store information that can be accessed by the computing device. Based on the definition in the present specification, the computer readable medium does not include transitory computer-readable medium, for example, a modulated data signal and carrier.

It is worthwhile to further note that the terms “include”, “comprise”, or their any other variant is intended to cover a non-exclusive inclusion, so a process, a method, merchandise, or a device that includes a list of elements not only include those elements but also includes other elements which are not expressly listed, or further includes elements inherent to such a process, a method, merchandise, or a device. An element preceded by “includes a . . . ” does not, without more constraints, preclude the existence of additional identical elements in the process, method, merchandise, or device that includes the element.

Specific implementations of the present application are described above, and any other implementations fall within the scope of the appended claims. In some situations, the actions or steps described in the claims can be performed in an order different from the order in the implementation and the desired results can still be achieved. In addition, the process described in the accompanying drawings does not necessarily require a particular execution order to achieve the desired results. In some implementations, multi-tasking and parallel processing can be advantageous.

The terms used in one or more implementations of the present specification are merely for the purpose of illustrating specific implementations, and are not intended to limit the present specification. The terms “a”, “said” and “the” of singular forms used in the implementations and the appended claims of the present specification are also intended to include plural forms, unless otherwise specified in the context clearly. It should also be understood that, the term “and/or” used in present specification indicates and includes any or all possible combinations of one or more associated listed items.

It should be understood that although terms “first”, “second”, “third” etc. can be used in the implementations of the present specification to describe various information, the information is not limited by the terms. These terms are only used to differentiate information of the same type. For example, without departing from the scope of one or more implementations of the present specification, first information can also be referred to as second information, and similarly the second information can also be referred to as the first information. Depending on the context, for example, the word “if” used here can be explained as “while”, “when”, or “in response to determining”.

The previous descriptions are only example implementations of the one or more implementations of the present specification, but are not intended to limit one or more implementations of the present specification. Any modification, equivalent replacement, improvement, etc. made without departing from the spirit and principle of the one or more implementations of the present specification shall fall within the protection scope of the one or more implementations of the present specification.

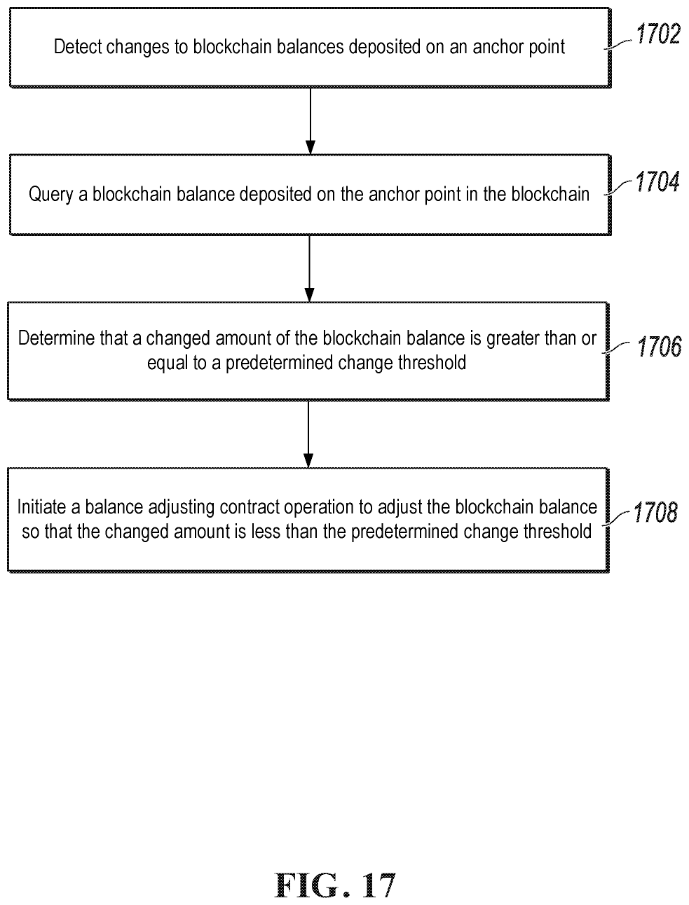

FIG. 17 is a flowchart illustrating an example of a computer-implemented method 1700 for adjusting blockchain balances, according to an implementation of the present disclosure. For clarity of presentation, the description that follows generally describes method 1700 in the context of the other figures in this description. However, it will be understood that method 1700 can be performed, for example, by any system, environment, software, and hardware, or a combination of systems, environments, software, and hardware, as appropriate. In some implementations, various steps of method 1700 can be run in parallel, in combination, in loops, or in any order.

At 1702, a node of a blockchain network detects changes to blockchain balances deposited on an anchor point in a blockchain maintained by the blockchain network, wherein the changes to the blockchain balances are caused by transactions submitted by one or more nodes of the blockchain network, wherein the node is associated with an entity participating in the blockchain network, and wherein the entity is associated with the anchor point.

At 1704, the node queries a blockchain balance deposited on the anchor point in the blockchain. In some cases, querying the blockchain balance deposited on the anchor point includes initiating, by the node, a balance querying contract operation to query the blockchain balance deposited on the anchor point. In some implementations, querying the blockchain balance deposited on the anchor point includes querying, by the node, the blockchain balance deposited on the anchor point at the beginning or end of a settlement cycle agreed to by a plurality of nodes in the blockchain network.

At 1706, the node determines that a changed amount of the blockchain balance is greater than or equal to a predetermined change threshold. In some cases, the changed amount is determined based on transactions recorded in the blockchain and between the node and other nodes of the blockchain network. In some cases, the changed amount comprises a net changed amount formed by transactions between the member and other members of the blockchain network.

At 1708, in response to determining that the changed amount of the blockchain balance is greater than or equal to a predetermined change threshold, the node initiates a balance adjusting contract operation to adjust the blockchain balance so that the changed amount is less than the predetermined change threshold. In some implementations, after the balance adjusting contract operation is completed, the blockchain balance deposited on the anchor point is adjusted so the changed amount is 0. In some cases, initiating the balance adjusting contract operation includes adjusting, by the node based on the balance adjusting contract operation, blockchain balances deposited on a plurality of anchor points by the entity when the entity separately deposits a blockchain balance on the plurality of anchor points. In some cases, initiating the balance adjusting contract operation includes adjusting, by the node based on the balance adjusting contract operation, an account owned by the entity. In some implementations, after the balance adjusting contract operation is completed, the anchor point is instructed to adjust the blockchain balance based on a credit for the entity. In some implementations, the blockchain balance deposited on the anchor point by the node is different from a specified amount. The balance adjusting contract operation may include adjusting the blockchain balance deposited on the anchor point by the entity to the specified amount. In some cases, the specified amount is determined through analysis by the node based on at least one of: historical change data of the blockchain balance deposited on the anchor point by the entity, or predicted data of transactions between entities participating in the blockchain.

In some cases, the method 1700 includes adjusting, by the node, the predetermined change threshold based on at least one of historical change data of the blockchain balance deposited on the anchor point by the entity, or predicted data of transactions between entities participating in the blockchain.

In some implementations, a node can be a computing device participating in the blockchain network (e.g., a “blockchain node”) and maintaining a blockchain structure. The node can communicate with other nodes participating in the blockchain network over a computer network, such as a local area network or the Internet. The node can receive broadcast notifications of transactions to be processed by the blockchain network, such as transferring portions of balances between accounts in the blockchain network, execution of smart contracts stored in the blockchain, state transitions of executing smart contracts, and other types of transactions.

The node can be associated with an entity or member, which can be a person, an organization (e.g., a corporation), a financial institution (e.g., a bank), or other entity. The entity may be associated with one or more accounts in the blockchain network. Transactions can be executed by the blockchain network to perform operations on the accounts, such as crediting or debiting a balance associated with the account.

The present techniques produce various technical effects. For example, the present techniques enable a node of a blockchain network to “top up” a balance deposited at an anchor point in the blockchain network in response to transaction activity. For example, when a transaction between two entities utilizes a particular anchor point, the balance at that anchor point may be debited by the amount of the transaction. If a second transaction is then attempted that would consume more than the remaining balance at the anchor point, this second transaction would fail due to insufficient available funds. By adjusting the balance at the anchor point when it is detected to change more than a predetermined amount, the anchor point will be more likely have sufficient funds for subsequent transactions. This may lead to greater efficiency and higher transaction throughput in the blockchain network, as the number of failed transactions due to insufficient funds will be reduced. This decrease in the number of failed transaction will also reduce the amount of network bandwidth and processing resources consumed by the blockchain network, as fewer transactions will be retried and reprocessed due to failures based on insufficient funds stored at the anchor points.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

1. A method for adjusting a blockchain balance, the method comprising:
detecting, by a node of a blockchain network, changes to blockchain balances deposited on an anchor point in a blockchain maintained by the blockchain network, wherein the changes to the blockchain balances are caused by transactions submitted by one or more nodes of the blockchain network, wherein the node is associated with an entity participating in the blockchain network, and wherein the entity is associated with the anchor point;
querying, by the node, a blockchain balance deposited on the anchor point in the blockchain;
determining, by the node, that a changed amount of the blockchain balance is greater than or equal to a predetermined change threshold; and
in response to determining that the changed amount of the blockchain balance is greater than or equal to a predetermined change threshold, initiating, by the node, a balance adjusting contract operation to adjust the blockchain balance so that the changed amount is less than the predetermined change threshold.

2. The method according to claim 1, wherein querying the blockchain balance deposited on the anchor point comprises:
initiating, by the node, a balance querying contract operation to query the blockchain balance deposited on the anchor point.

3. The method according to claim 1, wherein the changed amount is determined based on transactions recorded in the blockchain and between the entity and other entities participating in the blockchain network.

4. The method according to claim 1, wherein the changed amount comprises a net changed amount formed by transactions between the entity and other entities participating in the blockchain network.

5. The method according to claim 1, wherein querying the blockchain balance deposited on the anchor point comprises:
querying, by the node, the blockchain balance deposited on the anchor point at the beginning or end of a settlement cycle agreed to by a plurality of entities participating in the blockchain network.

6. The method according to claim 1, wherein after the balance adjusting contract operation is completed, the blockchain balance deposited on the anchor point is adjusted so the changed amount is 0.

7. The method according to claim 1, further comprising:
adjusting, by the node, the predetermined change threshold based on at least one of historical change data of the blockchain balance deposited on the anchor point by the node, or predicted data of transactions between nodes in the blockchain.

8. The method according to claim 1, wherein initiating the balance adjusting contract operation comprises:
adjusting, by the node based on the balance adjusting contract operation, blockchain balances deposited on a plurality of anchor points by the node when the node separately deposits a blockchain balance on the plurality of anchor points.

9. The method according to claim 1, wherein initiating the balance adjusting contract operation comprises:
adjusting, by the node based on the balance adjusting contract operation, an account owned by the entity associated with the node.

10. The method according to claim 1, wherein after the balance adjusting contract operation is completed, the anchor point is instructed to adjust the blockchain balance based on a credit for the entity.

11. The method according to claim 1, wherein the blockchain balance deposited on the anchor point by the node is different from a specified amount.

12. The method according to claim 11, wherein the balance adjusting contract operation comprises adjusting the blockchain balance deposited on the anchor point by the node to the specified amount.

13. The method according to claim 11, wherein the specified amount is determined through analysis by the node based on at least one of: historical change data of the blockchain balance deposited on the anchor point by the node, or predicted data of transactions between entities participating in the blockchain.

14. A non-transitory, computer-readable medium storing one or more instructions executable by a computer system to perform operations comprising:
detecting, by a node of a blockchain network, changes to blockchain balances deposited on an anchor point in a blockchain maintained by the blockchain network, wherein the changes to the blockchain balances are caused by transactions submitted by one or more nodes of the blockchain network, wherein the node is associated with an entity participating in the blockchain network, and wherein the entity is associated with the anchor point;
querying, by the node, a blockchain balance deposited on the anchor point in the blockchain;
determining, by the node, that a changed amount of the blockchain balance is greater than or equal to a predetermined change threshold; and
in response to determining that the changed amount of the blockchain balance is greater than or equal to a predetermined change threshold, initiating, by the node, a balance adjusting contract operation to adjust the blockchain balance so that the changed amount is less than the predetermined change threshold.

15. The computer-readable medium according to claim 14, wherein querying the blockchain balance deposited on the anchor point comprises:
initiating, by the node, a balance querying contract operation to query the blockchain balance deposited on the anchor point.

16. The computer-readable medium according to claim 14, wherein the changed amount is determined based on transactions recorded in the blockchain and between the entity and other entities participating in the blockchain network.

17. The computer-readable medium according to claim 14, wherein the changed amount comprises a net changed amount formed by transactions between the entity and other entities participating in the blockchain network.

18. The computer-readable medium according to claim 14, wherein querying the blockchain balance deposited on the anchor point comprises:
querying, by the node, the blockchain balance deposited on the anchor point at the beginning or end of a settlement cycle agreed to by a plurality of entities participating in the blockchain network.

19. The computer-readable medium according to claim 14, wherein after the balance adjusting contract operation is completed, the blockchain balance deposited on the anchor point is adjusted so the changed amount is 0.

20. A system, comprising:
one or more computers; and
one or more computer-readable memories coupled to the one or more computers and having instructions stored thereon which are executable by the one or more computers to:
detecting, by a node of a blockchain network, changes to blockchain balances deposited on an anchor point in a blockchain maintained by the blockchain network, wherein the changes to the blockchain balances are caused by transactions submitted by one or more nodes of the blockchain network, wherein the node is associated with an entity participating in the blockchain network, and wherein the entity is associated with the anchor point;
querying, by the node, a blockchain balance deposited on the anchor point in the blockchain;
determining, by the node, that a changed amount of the blockchain balance is greater than or equal to a predetermined change threshold; and
in response to determining that the changed amount of the blockchain balance is greater than or equal to a predetermined change threshold, initiating, by the node, a balance adjusting contract operation to adjust the blockchain balance so that the changed amount is less than the predetermined change threshold.
